(19) United States
(12) Patent Application Publication
(10) Pub. No.: US 2015/0313183 A1
(43) Pub. Date: Nov. 5, 2015

(54) PET PONCHO WITH ENHANCED COMFORT AND SAFETY

(71) Applicant: Pamela Rae Lerner, Bonita, CA (US)

(72) Inventor: Pamela Rae Lerner, Bonita, CA (US)

(21) Appl. No.: 14/702,015

(22) Filed: May 1, 2015

Related U.S. Application Data
(60) Provisional application No. 61/988,770, filed on May 5, 2014.

(51) Int. Cl. A01K 13/00

(52) U.S. Cl. CPC A01K 13/006

(57) ABSTRACT

A poncho for use with a pet to protect the pet from environmental elements and enhance safety by minimizing trip and choking hazards is provided. The poncho also prevents soiling, increases comfort, conserves body heat, and allows free movement of the pet's legs in all daily activities while reducing a likelihood of skin chafing experienced by the pet. The poncho includes a generally rectangular fabric layer having a front edge with a first portion and a second portion coupled together to create an opening sufficiently large to permit the pet's head to pass through, the rectangular fabric layer having an inner surface that rests on a body portion of the pet, and an elastic strap coupled to the inner surface of the rectangular fabric layer proximate the opening. The elastic strap conforms to contours of a chest region of the pet, thereby securing the poncho to the pet.

### RELATED APPLICATION

The application claims priority to provisional patent application U.S. Ser. No. 61/988,770 filed on May 5, 2014, the entire contents of which is herein incorporated by reference.

### BACKGROUND

The embodiments herein relate generally to ponchos for use with pets such as dogs and cats.

Pet ponchos protect pets from environmental elements such as cold temperatures, sun damage, rain, snow or wind. These ponchos may also serve as decorative apparel for pets. Current pet ponchos are ineffective because they do not adequately secure to the pet's body. These ponchos often are ill-fitting and fail to maintain their correct position, which is the shorter length at the front of the pet and the longer length down the entire back of the pet. Failure occurs when the longer length down the back of the poncho rotates around the pet's neck toward the front. This is problematic because the longer length rotating to the front of the pet increases the chance the pet will trip over the poncho and suffer injuries, and may be soiled by urine and feces. This rotation may also result in a failure to adequately cover and protect the pet's body, thereby exposing it to environmental elements.

There exist a variety of apparel or coats to protect pets from environmental elements as disclosed in U.S. Patent Application Publication 2005/0284418. However, these coats are disadvantageous because they only cover a portion of the pet such as the main torso, which exposes the pet's limbs. This is undesirable because exposed portions of the pet's body promote heat loss and reduced protection from the environment. In addition, these coats use hook and loop fasteners to secure the apparel to the pet. Other apparel use other components such as buttons, zippers or the like. These fastening components add stiffness to the coat and cause discomfort to the pet due to chafing and/or skin irritations, as well as a possible choking hazard.

As such, there is a need in the industry for a pet poncho that effectively secures to the pet, which addresses the limitations of the prior art. Specifically, a poncho is desired that reduces trip hazards by preventing the poncho from rotating out of position when worn by the pet. There is a further need in the industry for a pet poncho that hangs freely down on all sides of the pet, thereby allowing free movement of the pet's legs while adding more coverage, protection, comfort and conservation of the pet's body heat. There is a need in the industry for a pet poncho that is purely made from soft materials with no fasteners, hook and loop components, buttons, zippers, or the like. This eliminates the possible choking hazard, maximizes comfort to the pet and reduces chafing and/or skin irritations.

### SUMMARY

A poncho for use with a pet to protect the pet from environmental elements and enhance pet safety by preventing the poncho from rotating around and out of position when secured to the pet is provided. The poncho also minimizes trip and choking hazards, and the chance of being soiled by the pet. The poncho is configured to enhance comfort by reducing a likelihood of skin chafing to the pet. The poncho comprises a generally rectangular fabric layer comprising a front edge, a pair of side edges and a rear edge, the front edge comprising a first portion and a second portion coupled together to create an opening sufficiently large to permit a head of the pet to pass through, the rectangular fabric layer further comprising an inner surface configured to rest on a body portion of the pet, and an elastic strap coupled to the inner surface of the rectangular fabric layer proximate the opening, wherein the elastic strap is configured to conform to contours of a chest region of the pet, thereby securing the poncho to the pet.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the pet poncho shown in use;

FIG. 2 depicts a perspective view of certain embodiments of the pet poncho;

FIG. 3 depicts an exploded view of certain embodiments of the pet poncho;

FIG. 4 depicts a section view of certain embodiments of the pet poncho taken along line 4-4 in FIG. 2;

FIG. 5 depicts a section view of certain embodiments of the pet poncho taken along line 5-5 in FIG. 4;

FIG. 6 depicts a top view of certain embodiments of the pet poncho;

FIG. 7 depicts a bottom view of certain embodiments of the pet poncho; and

FIG. 8 depicts a top view of certain embodiments of the pet poncho prior to a final assembled configuration.

### DETAILED DESCRIPTION OF CERTAIN EMBODIMENTS

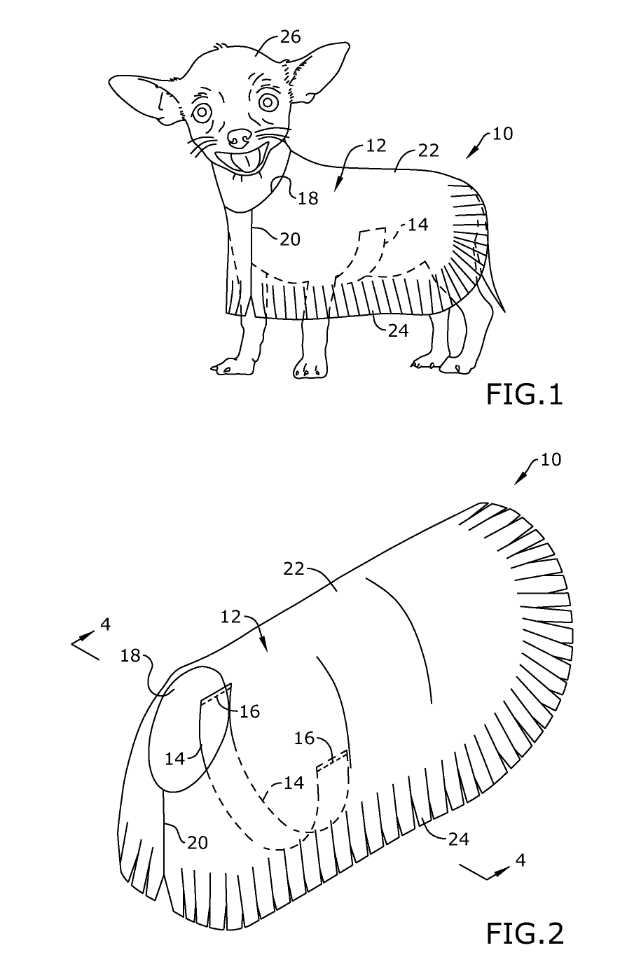

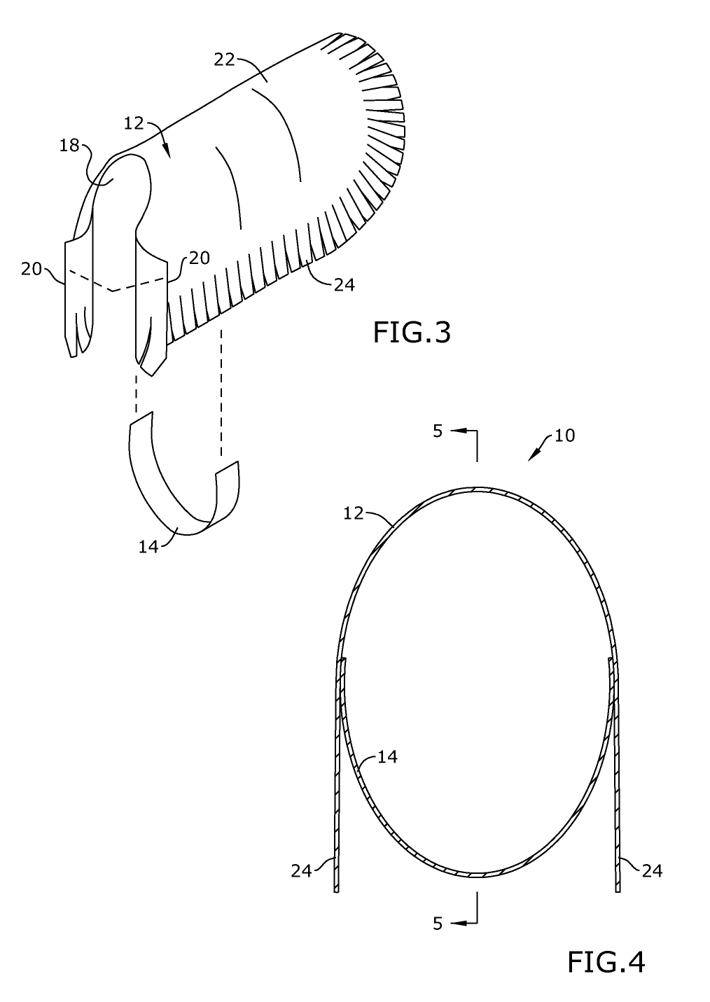

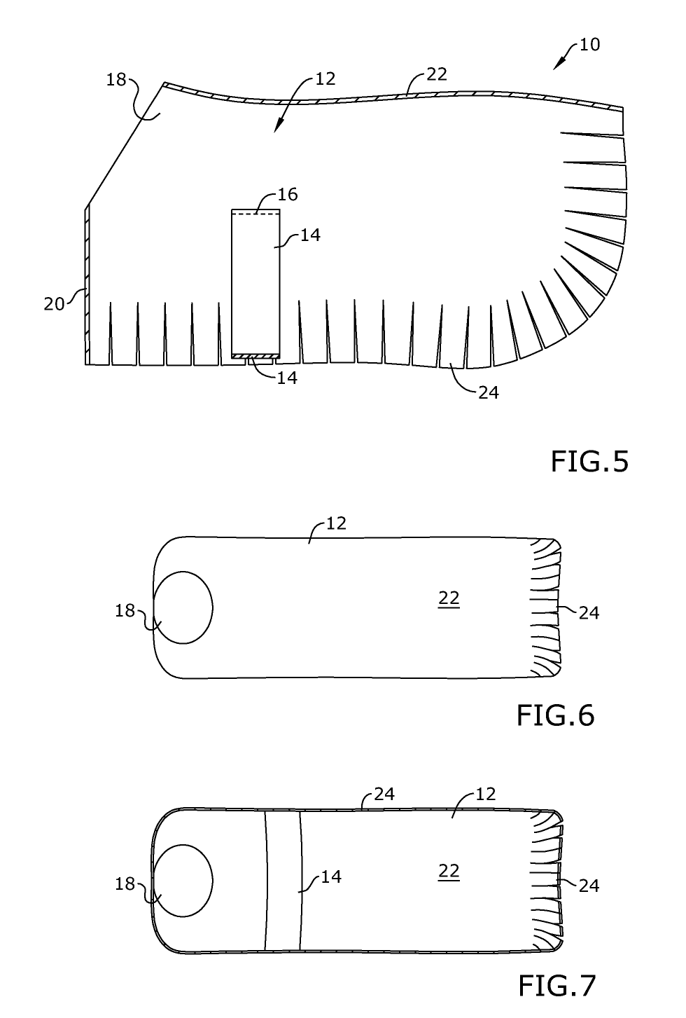

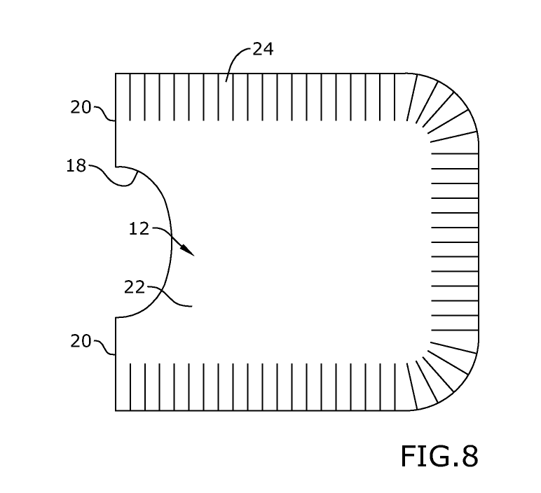

As depicted in FIG. 1, poncho 10 is configured to be worn by pet 26. Pet 26 may be any pet including, but not limited to, dogs or cats. As depicted in FIGS. 2-7, poncho 10 is made from fabric layer 12 and elastic strap 14. FIG. 8 depicts poncho 10 prior to the final assembled configuration.

Fabric layer 12 is a generally rectangular layer comprising body section 22, a front edge, side edges and a rear edge. In a preferred embodiment, fabric layer 12 is made from fleece fabric, but any alternative materials known in the field may be used such as vinyl or leather. Fabric layer 12 preferably has an approximate width of 11-25 inches and length of 11½-26¾ inches. However, dimensions of fabric layer 12 may vary outside of these ranges. The front edge of fabric layer 12 comprises a pair of flaps 20, which are coupled together by stitching to create neck hole 18. Neck hole 18 has dimensions sufficiently large to permit the neck of pet 26 to pass through when poncho 10 is worn.

It shall be appreciated that fabric layer 12 may have any decorations or designs affixed thereon such as bows, bowties, ribbons, lace, flowers, stitching, paint, visibility enhancers, LED lights, reflective tape, or the like. In one embodiment, fabric layer 12 may optionally have decorative fringe 24 along the rear edge and side edges. In an alternative embodiment of the invention, one or more additional layers (not shown) may be affixed to fabric layer 12, which may include, but is not limited to, fabric, reflective and/or water resistant layers. These additional layer(s) provide pet 26 additional warmth and protection from environmental elements.

Elastic strap 14 is preferably made from spandex and has an approximate width of 2-4 inches and length of 6-13½ inches. Any alternative elastic material may be used for elastic strap 14. The dimensions of elastic strap 14 may vary to accommodate any type and sized pet. Each end of elastic strap 14 is affixed to an inner surface at both side chest areas of fabric layer 12 proximate neck hole 18 by stitching 16. FIG. 4 depicts the loop created by chest strap 14 and fabric layer 12 when assembled.

To operate poncho 10, the head of pet 26 is placed through the loop created by elastic strap 14 and fabric layer 12, and neck hole 18. This permits the pet's head to extend outside of poncho 10. The legs of pet 26 are placed one at a time through the loop in elastic strap 14. Once completed, elastic strap 14 conforms to contours of the pet's chest region. This secures poncho 10 in place on pet 26 and prevents fabric layer 12 from rotating out of place and creating a trip hazard or being soiled. Elastic strap 14 is not visible when poncho 10 is secured to pet 26 as the front, side and rear edges of poncho 10 hang freely straight down in a poncho-like manner. Since fabric layer 12 hangs down freely along the sides of pet 26, the pet is not restricted in any movements or from participating in any activities such as walking, running, jumping, sleeping, and the like. If pet 26 crouches or lies down, fabric layer 12 will completely enclose the pet's legs for enhanced protection and warmth.

It shall be appreciated that poncho 10 has several additional advantages over existing pet ponchos and/or apparel. Unlike existing pet ponchos and/or apparel that extend partly down the pet's back, poncho 10 extends the entire length of the pet's back from the base of the neck to the base of the tail. This enhances the poncho's coverage on the pet's body and protection from environmental elements while minimizing heat loss. Since the components of poncho 10 are soft and do not rely on hooks, loops, buttons, buckles or other fasteners with sharp or stiff components, the chance pet 26 suffers any skin irritations, chafing, pinching, choking, discomfort or other injury is greatly reduced or eliminated. The design of poncho 10 is also advantageous because it minimizes the chance of becoming soiled when pet 26 urinates or defecates. The free hanging fabric layer 12 permits pet 26 to squat and/or lift a leg to move any portion of the layer out of the way as needed.

It shall be appreciated that the components of poncho 10 described in several embodiments herein may comprise any alternative known materials in the field and be of any color, size and/or dimensions. This allows the poncho to accommodate any variety and sized pets. It shall be appreciated that the components of poncho 10 described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A poncho for use with a pet to protect the pet from environmental elements and enhance pet safety by minimizing trip and choking hazards, the poncho further configured to enhance comfort by reducing a likelihood of skin chafing to the pet, the poncho comprising:
a generally rectangular fabric layer comprising a front edge, a pair of side edges and a rear edge, the front edge comprising a first portion and a second portion coupled together to create an opening sufficiently large to permit a head of the pet to pass through, the rectangular fabric layer further comprising an inner surface configured to rest on a body portion of the pet; and
an elastic strap coupled to the inner surface of the rectangular fabric layer proximate the opening, wherein the elastic strap is configured to conform to contours of a chest region of the pet, thereby securing the poncho to the pet.

2. The poncho of claim 1, wherein the first portion and second portion of the front edge are coupled together by stitching.

3. The poncho of claim 2, wherein the elastic strap is coupled to the inner surface of the rectangular fabric layer by stitching.

4. The poncho of claim 3, wherein the pair of side edges and the rear edge of the rectangular fabric layer each comprises a decorative fringe.

5. The poncho of claim 3, further comprising a second fabric layer affixed to the generally rectangular fabric layer.
